(19) United States
(12) Patent Application Publication
(10) Pub. No.: US 2003/0120930 A1
(43) Pub. Date: Jun. 26, 2003

(54) Document notarization system and method

(76) Inventors: Shell S. Simpson, Boise, ID (US); Ward S. Foster, Boise, ID (US)

Correspondence Address: HEWLETT-PACKARD COMPANY, Intellectual Property Administration, P.O. Box 272400, Fort Collins, CO, 80527-2400, US

(21) Appl. No.: 10/029,960

(22) Filed: Dec. 21, 2001

(51) Int. Cl. H04L 9/00

(52) U.S. Cl. 713/178

(57) ABSTRACT

The present disclosure relates to a document notarization system and method. In one arrangement, the system and method pertain to accessing imaging data via a network, and electronically notarizing the imaging data. By way of example, notarization can comprise modifying an original document by adding a stamp and/or a digital signature or generating a separate (or appended) notarization certificate. The present disclosure further relates to a network-based notarization service stored on computer-readable media. In one arrangement, the notarization service comprises logic configured to access a document stored in a personal imaging repository, and logic configured to electronically notarize the document.

### FIELD OF THE INVENTION

The present disclosure relates to a system and method for notarizing imaging data such as documents. More particularly, the disclosure relates to a web-based imaging system and method having a distributed architecture with which electronic notarization services can be provided.

### BACKGROUND OF THE INVENTION

As computer technology has advanced, the role of computers in our daily lives has expanded, as has the need for various peripheral or supporting devices. One typical peripheral device used with computers is a printer, which generates hard copies of electronic data. The types and capabilities of available printers has similarly been expanding, resulting in a wide variety of printers with a range of printing capabilities, performance, and price.

One significant expansion in the use of computer technology is the networking of computers. Networking computers together allows the computers to communicate with one another as well as with other devices, such as printers. As computer networks, such as the Internet, continue to develop, there is increasing demand for additional and improved functionalities that draw upon and exploit the full computing potential of computer networks.

Despite the availability and convenience of such computer networks, notarization is typically achieved by generating a hard copy document, bringing it to a notary public (i.e., a human being), and having the notary public physically stamp and sign the document. Although this process is useful in proving the authenticity of certain documents, it is highly inconvenient, particularly in view of the vast communication options available today. A more convenient system would utilize computer network resources as well as the various security resources (e.g., digital signature technology) that are currently available.

### SUMMARY OF THE INVENTION

The present disclosure relates to a document notarization system and method. In one arrangement, the system and method pertain to accessing imaging data via a network, and electronically notarizing the imaging data. By way of example, notarization can comprise modifying an original document by adding a stamp and/or a digital signature, or generating a separate (or appended) notarization certificate.

The present disclosure further relates to a network-based notarization service stored on computer-readable media. In one arrangement, the notarization service comprises logic configured to access a document stored in a personal imaging repository, and logic configured to electronically notarize the document.

Other systems, methods, features, and advantages of the invention will become apparent upon reading the following specification, when taken in conjunction with the accompanying drawings.

### BRIEF DESCRIPTION OF THE DRAWINGS

The invention can be better understood with reference to the following drawings. The components in the drawings are not necessarily to scale, emphasis instead being placed upon clearly illustrating the principles of the present invention.

FIG. 1 is a schematic representation of the general operation of the invention.

FIG. 2 is an example distributed system in which the invention can be implemented.

FIG. 3 is a first example web-based imaging system in which the invention can be implemented.

FIG. 4 is a second example web-based imaging system in which the invention can be implemented.

FIG. 5 is a schematic of an imaging client device shown in FIGS. 3 and 4.

FIG. 6 is a flow diagram that provides an overview of the manner in which the inventive system can be used to support notarization.

FIG. 7 is a flow diagram of an example of using an imaging source to create and/or identify imaging data to be notarized.

FIGS. 8A and 8B provide a flow diagram illustrating an example of operation of an image destination in providing electronic notarization.

### DETAILED DESCRIPTION

Disclosed is a system and method for notarization. In some arrangements, the system has a distributed architecture with which a user can maintain imaging data that, for instance, comprises one or more documents. In such a scenario, the user may access a network-based (e.g., web-based) imaging service that enables the user to store imaging data in the user's personal imaging repository. Once the imaging data have been stored in the user's personal imaging repository, the user can access a network-based (e.g., web-based) notarization service that can access the imaging data and notarize it in some manner.

To facilitate description of the inventive system and method, example systems are discussed with reference to the figures. Although these systems are described in detail, it will be appreciated that they are provided for purposes of illustration only and that various modifications are feasible without departing from the inventive concept. After the description of the example systems, examples of operation of the systems are provided to explain the manners in which the notarization services can be provided.

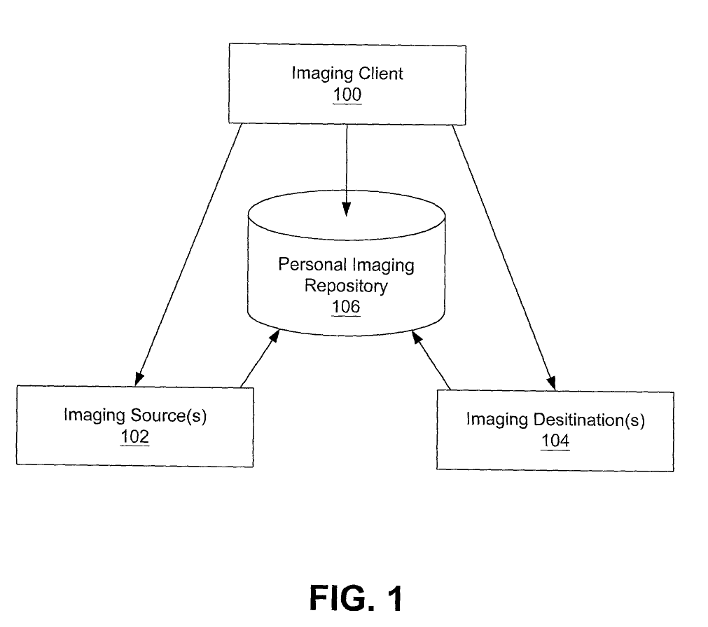

FIG. 1 is a schematic representation of the general operation of the invention. As shown in this figure, an imaging client 100 communicates with one or more imaging sources 102, one or more imaging destinations 104, and a personal imaging repository 106. The imaging source(s) 102 represent any of a wide variety of devices/services that can be accessed by the imaging client 100 and used to select or identify imaging data to be used to create a document.

The personal imaging repository 106 provides image storage facilities that typically are personalized for the individual imaging client 100. The imaging repository 106 can be located in various different places. For example, the repository 106 can be maintained on one or more computing devices associated with the imaging client 100, imaging source(s) 102, or imaging destination(s) 104. Alternatively, the repository 106 can be maintained on a separate computing device (e.g., server) that the imaging client 100, imaging source(s) 102, and imaging destination(s) 104 can access. The imaging data in the imaging repository 106 can be any type of printable data, such as text, graphics, frames of video or animations, pictures, combinations thereof, and so forth.

Once imaging data is stored in the personal imaging repository 106, the imaging client 100 can select data from the repository that is to be communicated to the imaging destination(s) 104 for some form of processing or manipulation. For instance, the data are communicated to the image destination(s) 104 for notarization. As will be apparent from the discussions that follow, the above-described manner of operation provides a high degree of personalization to the imaging client 100. Specifically, in that the client's personal information can be accessed and utilized with any participating service (e.g., web site) used by the client, each service can be customized for the user.

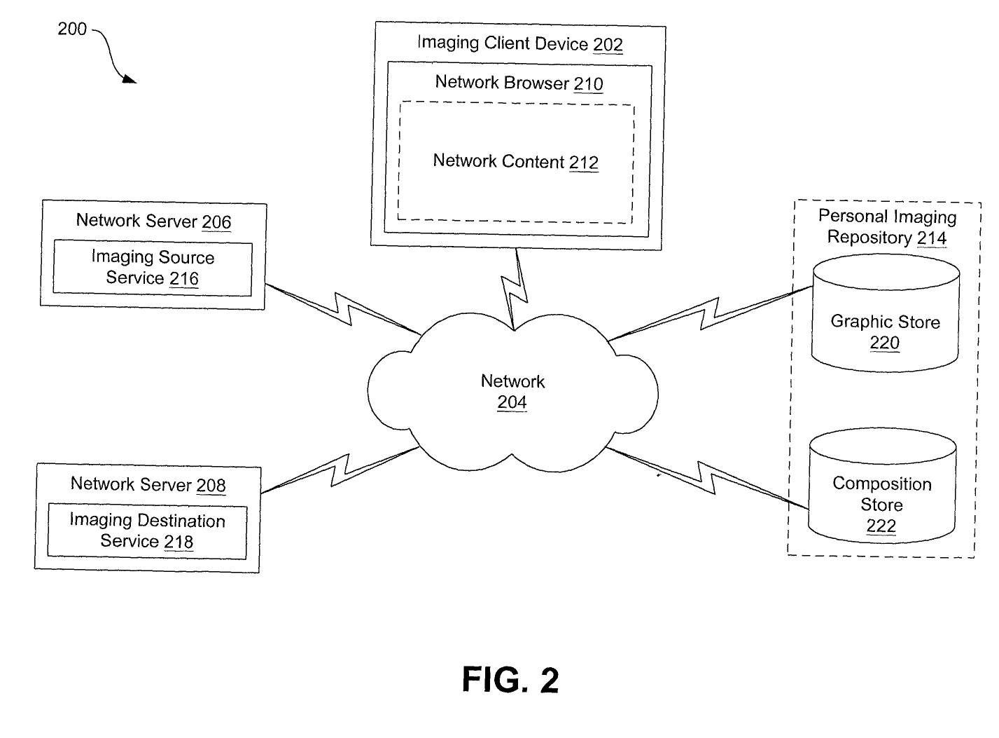

FIG. 2 illustrates an example distributed system 200 in which the invention can be implemented. As indicated in FIG. 2, the system 200 includes an imaging client device 202 that is coupled to a network 204. Through this coupling, the imaging client device 202, and therefore the imaging client (i.e., user), can be placed in communication with one or more network servers, such as servers 206 and 208. The client device 202 and network servers 206 and 208 represent any of a wide variety of conventional wired and/or wireless computing devices, such as desktop computers, portable computers, dedicated server computers, multi-processor computing devices, personal digital assistants (PDAs), mobile telephones, pen-based computers, gaming consoles, and so forth.

The network 204 represents one or more data distribution networks that can be used to communicate data and other information (e.g., control information) between or among various computing devices. Examples for the network 204 include the Internet, a local area network (LAN), a public or private wide area network (WAN), and combinations thereof. The network 204 can further include various different types of networks, including wired and/or wireless portions, employing any of a wide variety of different communications protocols including public and/or proprietary communications protocols.

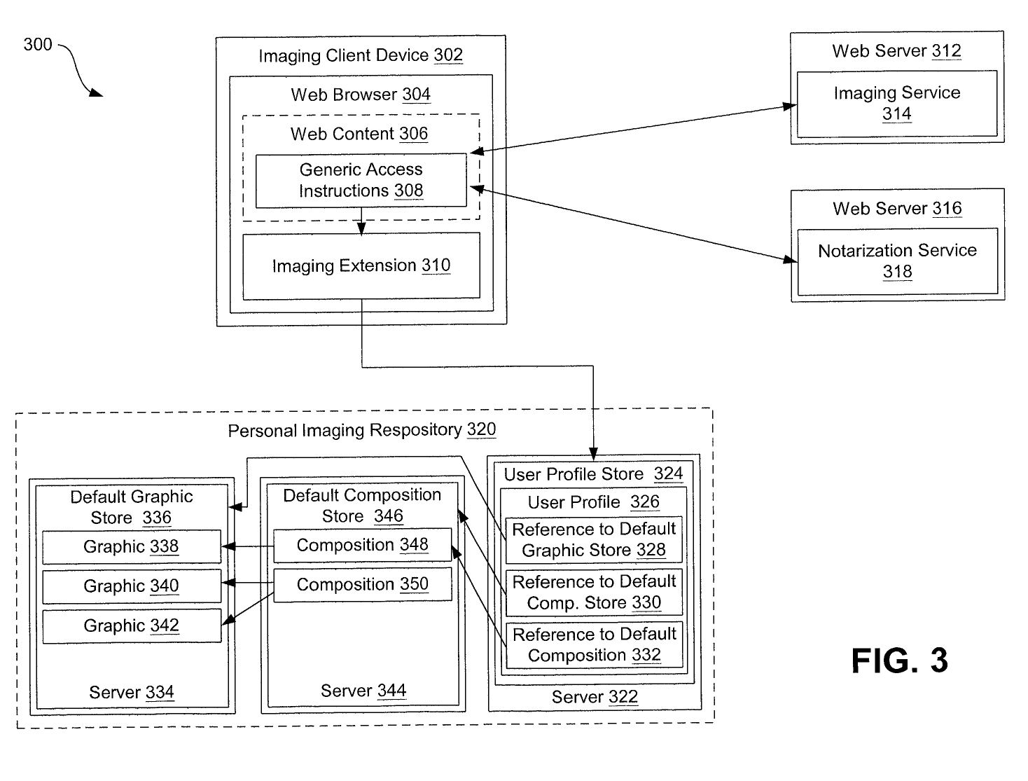

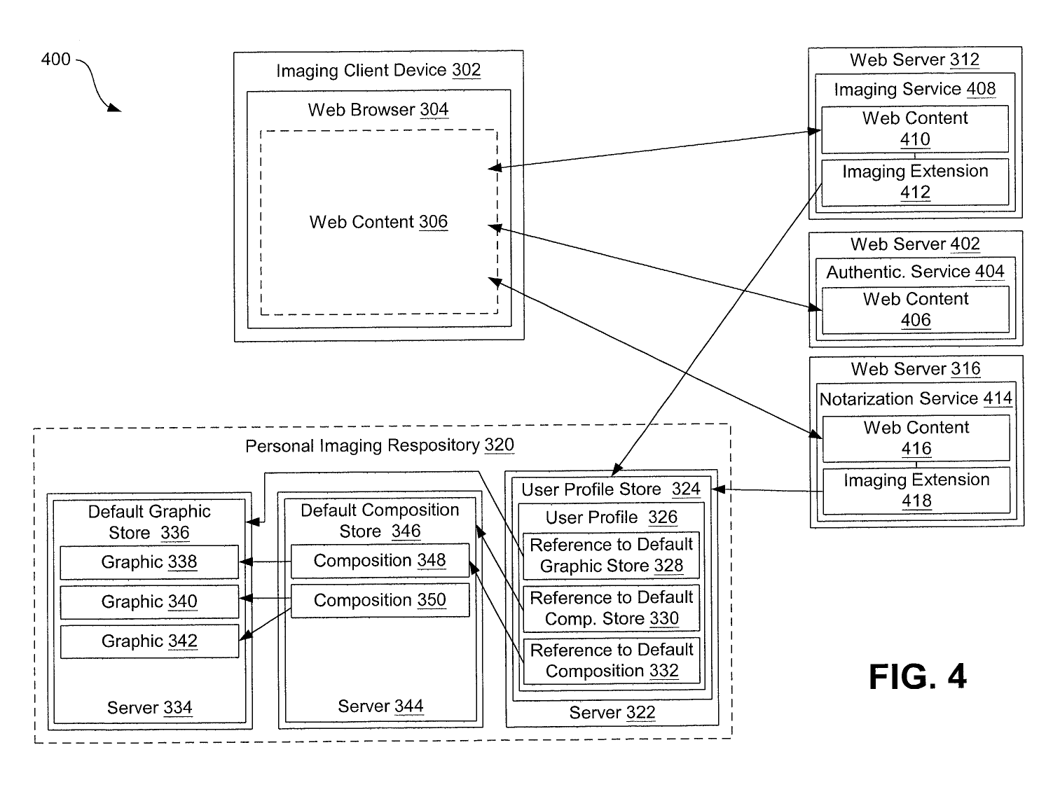

During operation, the user can operate a network browser 210 executing on the imaging client device 202 to interact with imaging services 216, 218 executing on the network servers 206 and 208. As used herein, the term “services” refers to software and/or firmware components that can execute on one or more computing devices and which provide one or more particular functionalities to the imaging client device 202 such as imaging data selection and arrangement, data manipulation, and so forth. As indicated in FIG. 2, the network browser 210 can receive network content 212 from one or more of the network servers 206 and 208. This content 212 typically includes various components such as, for example, text, graphics, and various commands (e.g., hypertext mark-up language (HTML), Java™, JavaScript™, etc.) and/or applications (e.g., Java™ applets). In use, the content 212 can, in some arrangements, facilitate communication with a personal imaging repository 214 so that the servers 206 and 208 can access data stored in the repository. Examples of the ways in which this communication can be facilitated are described below with reference to FIGS. 3 and 4.

The network server 206 executes an imaging source service 216 that, among other things, allows the user to interact with his or her personal imaging repository 214. The imaging source service 216 may actually provide multiple services that can be accessed. In some embodiments, these different services can provide different functionalities. For instance, one service may be responsible for graphic storage and retrieval while another service may be responsible for merging graphics in a single document. By accessing these services with the network browser 210, the user can select or identify imaging data that are to be stored as graphics in a graphic store 220 of the personal imaging repository 214. These graphics can be stored as individual files and generally can comprise any data capable of being represented as a two dimensional graphic. As is discussed below, the individual graphics in store 220 can be used as individual images that can be printed on appropriate print media, or multiple individual graphics can be compiled together as a single image for printing.

Irrespective of whether multiple graphics are to be used, the imaging source service 216 can be used to arrange the graphic(s) on a visual representation of a document. Once the arrangement has been selected, the imaging source service 216 can store the arrangement as a composition (i.e., a composition image) in a composition store 222 of the personal image repository 214. It is to be noted that, although the graphic store 220 and the composition store 222 are illustrated as two separate stores, multiple such stores may exist in the system 200 and one or more graphic stores may be combined with one or more composition stores. Additionally, one or more of these stores 220 and 222 may be implemented on the imaging client device 202, one or more of the servers 206 or 208, or another designated computing device (not shown).

Once the graphics and composition have been selected, the imaging data can be processed or otherwise manipulated by accessing an imaging destination service 218 that executes on the network server 208. To do this, the network server 208 interacts with the graphic store 220 and composition store 222 to retrieve the data needed to perform the processing and/or manipulation.

FIG. 3 illustrates a first example web-based imaging system 300 in which the invention can be implemented. As will be appreciated from the discussion that follows, this system 300 can be described as a client-based implementation in that much of the system functionality is provided by a client device. A similar system is described in detail in U.S. patent application Ser. No. 09/924,058, entitled “A Method, System and Program Product for Multiprofile Operations and Expansive Profile Operation,” by Shell Simpson, Ward Foster, and Kris Livingston and bearing Attorney Docket No. 10007690-1, the disclosure of which is hereby incorporated by reference into the present disclosure.

As indicated in FIG. 3, the system 300 includes an imaging client device 302. The imaging client device 302 comprises a web browser 304 that is adapted to access web content 306 derived from an imaging service 314 and notarization service 318 of web servers 312 and 316, respectively. The web content 306, like content 212, typically comprises text, graphics, and various commands. The commands can comprise one or more sets of executable instructions that are downloaded into the browser 304 to perform a service requested by the user. These instructions can be written in any suitable language including, for instance, HTML, Java™, JavaScript™, C-sharp, or other appropriate language. A variety of different functionalities can be served by the executable instructions. For example, the web content 306 normally includes executable instructions for causing target graphics, i.e. graphics provided by an accessed web site, to be displayed to the user.

In the embodiment shown in FIG. 3, the executable instructions are further used to access a personal imaging repository 320. These instructions typically comprise system-wide generic access instructions 308 that call on methods of an imaging extension 310 to access the personal imaging repository 320 and perform various web imaging operations. These instructions 308 are designated as “generic” because they are independent of the configuration of the user's personal imaging repository 320. As is discussed in greater detail below, the generic access instructions 308 can be used to, for example, add a graphic to a default graphic store 336 of the personal imaging repository 320, or add a new composition to a default composition store 346 of the repository.

As is further indicated in FIG. 3, the imaging extension 310 can form part of the browser 304. Although this arrangement is shown in the figure and described herein, the imaging extension 310 can, alternatively, be provided outside of the browser 304, for instance on a different device. Irrespective of its location, however, the imaging extension 310 is configured to respond to the execution of the generic access instructions 308 by generating/mapping to corresponding imaging client specific commands of the user. The imaging extension 310 typically is implemented as one or more application programming instructions (APIs) that, preferably, act as interfaces in accordance with a system-wide standard.

When executed, the generic access instructions 308 cause imaging extension calls (e.g., API calls) to be issued which, in turn, cause the imaging extension 310 (e.g., APIs) to access to the user's personal imaging repository 320. The web content 306 therefore uses the imaging extension 310 as a gateway to access the user's personal imaging repository 320. Generally speaking, the APIs can comprise sets of methods for establishing a destination for redirecting the browser 304 based on some form of received redirection initiation. In such circumstances, the process normally comprises receiving a redirection initiation to redirect the browser 304, retrieving a direct or indirect reference to a destination, and then causing the browser to browse to that destination. It will be recognized that there are many other ways (both in hardware and software) to implement this same functionality.

In some arrangements, the imaging extension 310 is configured to prevent the web content 306 (i.e., the executable instructions from one or more web services), from arbitrarily accessing the user's personal imaging repository 320. This restricted access can be imposed upon the web content 306 using a variety of methods. For example, an imaging extension API can be configured to only accept references from the web content 306 that were previously provided by the imaging extension 310. In such a scenario, the content 306 cannot arbitrarily supply references when calling the imaging extension API. Therefore, in order to access the user's personal imaging repository 320, the web content 306 must first obtain references using the imaging extension API.

The imaging extension 310 can be used to access one or more user profiles 326 that is/are stored in a user profile store 324 of a server 322 of the personal imaging repository 320. By way of example, the imaging extension 310 can be directed to the user profile 326 with a uniform resource locator (URL), pointer, socket, or other backroom detail. In some embodiments, the same user can have multiple user profiles. This may be particularly advantageous when a firewall (not shown) is used in that different graphic stores and composition stores can be used depending on whether the user is inside or outside of the firewall.

The user profile 326 typically includes references to all or a portion of the personal imaging repository 320 for that user profile. For instance, as shown in FIG. 3, the user profile 326 can include a reference 328 to a default graphic store, a reference 330 to a default composition store, and a reference 332 to a default composition. In use, the user profile 326 functions as a service that uses appropriate methods to create, modify, access, and cancel profiles. Accordingly, the imaging extension 310 maps to the appropriate methods (i.e., makes use of the methods) in the user profile 326 to obtain the reference to various repository items such as the default graphic store 336 and the default composition store 346.

Like the user profile store 324, the default graphic store 336 and default composition store 346 can reside on separate servers 334 and 344. It will be understood, however, that one or more of the stores could reside on a single machine, if desired. As indicated in FIG. 3, the default graphic store 336 is used to store various graphics, such as graphics 338, 340 and 342. These graphics can be stored in substantially any format. For example, these formats can comprise PDF, JPEG, PostScript, TIFF, GIF, BMP, etc. In addition, the default graphic store 336 can include one or more APIs. Therefore, in contrast to merely providing for graphic storage, the graphic store 336 can also provide services used to create, retrieve, and/or manipulate graphics. Furthermore, the default graphic store 336 can communicate with the web content of various web services. For example, notarization service 318 can submit queries to the default graphic store 336 (via the extension 310) as well as request that one or more graphics be transmitted in a desired arrangement to the notarization service.

The default composition store 346 stores various compositions, such as compositions 348 and 350, which can be used to arrange the selected graphics. Like the user profile store 324 and default graphic store 336, the default composition store 346 can also comprise various APIs that can access graphics from the graphic store, manipulate the graphics, etc.

FIG. 4 illustrates a second example web-based imaging system 400 in which the invention can be implemented. As indicated in FIG. 4, the system 400 includes many of the features of the system 300 shown in FIG. 3. Therefore, the system 400 includes an imaging client device 302 that executes a web browser 304 to receive web content 306. The system 400 also includes a personal imaging repository 320 that can, for instance, comprise a user profile store 324, a default graphic store 336, and a default composition store 346. Furthermore, the system 400 includes web servers 312 and 316. Each of these components is generally configured in similar manner as the like-named and numbered features identified in FIG. 3. However, unlike the client-based system 300, the system 400 provides a server-based implementation in which much of the functionality provided by the client device 302 in the system 300 is transferred to another device. By way of example, this other device can comprise a further web server 402, which executes an authentication service 404. As shown in FIG. 4, the authentication service 404 comprises web content 406 (e.g., generated on the fly) that can be downloaded into the user's browser 304.

In addition to the above-noted differences, the servers 312 and 316 are provided with different software in the system 400 to permit alternative modes of operation. By way of example, the web server 312 can execute an imaging service 408, which includes web content 410 and an imaging extension 412. Similarly, the web server 316 can execute a notarization service 414 that includes web content 416 and an imaging extension 418. Like the web content from the imaging service 314 and the notarization service 318 of the system 300, the web content 410 and web content 416 typically comprise text and graphics that can be downloaded into the user's browser 304. Unlike the system 300, however, generic access instructions need not be downloaded into the browser 304 in that the browser does not comprise its own imaging extension. Such an arrangement is advantageous where the client device 302 has limited storage capacity (e.g., for PDAs, mobile telephones). Instead, as identified above, the services 408 and 414 include their own imaging extensions 412 and 418 that can be used to access the user's personal imaging repository 320. By way of example, the content 410 and 416 comprise server-side code including one or more of TM TM PHP script, Java Servlets, Java server pages (JSPs), active server pages (ASPs), etc.

Each of the imaging extensions 412 and 418 typically has a configuration that is similar to that of the imaging extension 310. Therefore, the imaging extensions 412 and 418 can comprise one or more APIs that, when executed, access to the user's personal imaging repository 320. Again, the APIs can comprise sets of methods for establishing a destination for redirecting the browser 304 based on some form of received redirection initiation. The APIs can implement, for instance, a URL, pointer, socket, or other backroom detail to facilitate the redirection.

The manner in which the personal imaging repository 320 is accessed by the services in the system 400 will now be discussed with reference to an example scenario. In this example, the user browses to the imaging service 408 using the web browser 304 of the client device 302. Upon reaching the service 408, web content 410 is executed to generate web pages that are downloaded to the web browser 304 (as content 306). Once this occurs, the browser 304 is redirected by the content 306 to the authentication service 404 that resides on the web server 402. Typically, this is accomplished by the web content 410 by generating a hypertext transfer protocol (HTTP) redirect that, when downloaded to the browser 304, causes the browser to redirect to an address (e.g., URL) identified in the header entry. Web content is then downloaded to the web browser 304 and the user is provided with an opportunity to complete an authentication procedure that identifies both the user's identity and the location of the user's personal imaging repository 320. The authentication procedure can, for example, comprise entry of authentication information, such a user name and password, that has been registered with the authentication service 404, for example, in a previous session. This information can be entered in a web page generated by the server 402. In an alternative arrangement, the authentication procedure can comprise the reading of a user identification card, which includes storage media (e.g., magnetic strip) that contains the user's authentication information. Persons having ordinary skill in the art will recognize that many other authentication alternatives exist.

Once the authentication procedure is successfully completed by the user, the browser 304 is again redirected, this time back to the imaging service 408. The redirection address (e.g., URL) used to revisit the imaging service 408 contains information that identifies the user and information identifying the user's personal imaging repository 320 (e.g., with a further URL). To avoid continual redirection back and forth, a “cookie” can be stored on the client device 302 that permits the authentication service 404 to validate the user's identity without requiring a further log in. Once this information is possessed by the imaging service 408, the service can, when appropriate, make calls to its imaging extension 412 (e.g., API calls) to command the imaging extension to access the user profile store 324 of the personal imaging repository 320. Through this access, the imaging service 408 can be used by the user to, for instance, select or identify imaging data to be stored as graphics in the default graphic store 336.

When the notarization service 414 is accessed, various content is downloaded to the web browser 306. The notarization service 414 can then access the default graphic store 336 and default composition store 346 such that the imaging data stored therein (e.g., documents) can be notarized.

As noted above, the default graphic store 336 may be used by imaging sources 102 that lack their own internal graphic store. Although, as described above in relation to FIGS. 3 and 4, the default graphic store 336 may be used by the imaging destination 104 to access the imaging data, more generally the imaging destination (e.g., notarization service) uses the default composition, which may or may not be stored in the default composition store 346, to determine which graphics are to be accessed. Notably, these graphics may or may not be stored in the default graphic store 336.

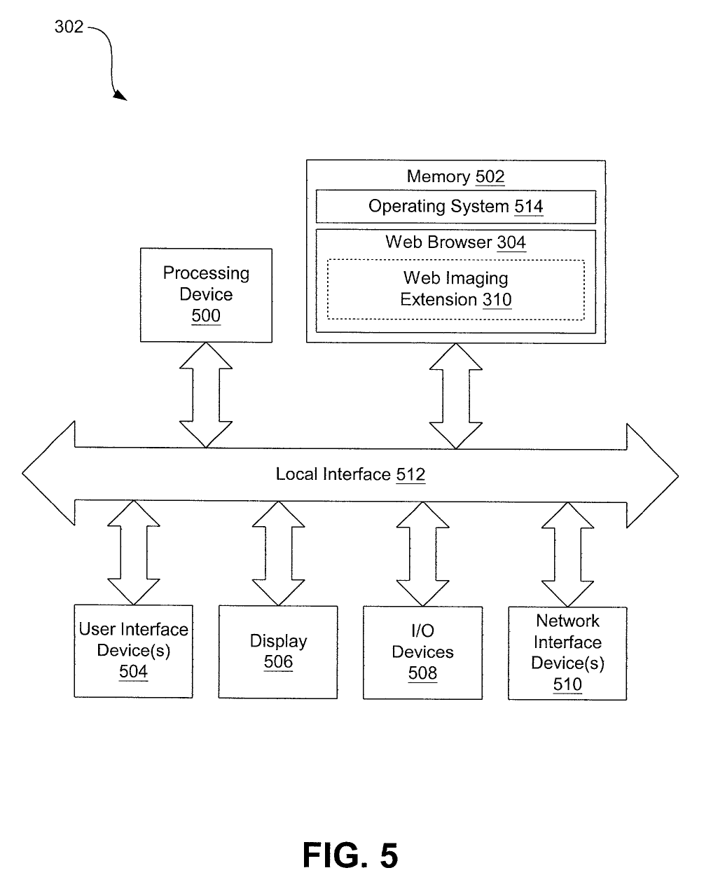

FIG. 5 is a schematic view illustrating an example architecture for the imaging client device 302 identified in FIGS. 3 and 4. As identified above, the client device 302 can be any one of a wide variety of conventional wired and/or wireless computing devices, such as desktop computers, portable computers, dedicated server computers, multi-processor computing devices, cellular telephones, PDAs, handheld or pen-based computers, gaming consoles, and so forth. Irrespective its type, the client device 302 typically comprises a processing device 500, memory 502, one or more user interface devices 504, a display 506, one or more input/output (I/O) devices 508, and one or more networking devices 510, each of which is connected to a local interface 512.

The processing device 500 can include any custom made or commercially available processor, a central processing unit (CPU) or an auxiliary processor among several processors associated with the client device 302, a semiconductor based microprocessor (in the form of a microchip), a macroprocessor, one or more application-specific integrated circuits (ASICs), a plurality of suitably configured digital logic gates, and other well known electrical configurations comprising discrete elements both individually and in various combinations to coordinate the overall operation of the client device 302. The memory 502 can include any one of a combination of volatile memory elements (e.g., random access memory (RAM, such as DRAM, SRAM, etc.)) and nonvolatile memory elements (e.g., ROM, hard drive, tape, CDROM, etc.).

The one or more user interface devices 504 comprise those components with which the user can interact with the client device 302. For example, where the client device 302 comprises a personal computer (PC), these components can comprise a keyboard and mouse. Where the client device 302 comprises a handheld device (e.g., PDA, mobile telephone), these components can comprise function keys or buttons, a touch-sensitive screen, a stylus, etc. The display 506 can comprise a computer monitor or plasma screen for a PC or a liquid crystal display (LCD) for a handheld device.

With further reference to FIG. 5, the one or more I/O devices 508 are adapted to facilitate connection of the client device 302 to another device and may therefore include one or more serial, parallel, small computer system interface (SCSI), universal serial bus (USB), IEEE 1394 (e.g., Firewire™), and/or personal area network (PAN) components. The network interface devices 510 comprise the various components used to transmit and/or receive data over a network (e.g., network 204 in FIG. 2). By way of example, the network interface devices 510 include a device that can communicate both inputs and outputs, for instance, a modulator/demodulator (e.g., modem), wireless (e.g., radio frequency (RF)) transceiver, a telephonic interface, a bridge, a router, network card, etc.

The memory 502 normally at least comprises an operating system 514 and a web browser 304. The operating system 514 controls the execution of other software and provides scheduling, input-output control, file and data management, memory management, and communication control and related services. As noted above with reference to FIGS. 3 and 4, the web browser 304 comprises software and/or firmware that is used to access various services over a network (e.g., Internet) and, therefore, download content from various different sources. Where the web browser 304 is configured as indicated in FIG. 3, the browser can comprise an imaging extension 310. However, it will be understood that where the system is arranged as indicated in FIG. 4, the imaging extension 310 need not be provided in the browser 304.

The architecture of the various servers shown in FIGS. 3 and 4 are typically similar to that described above with reference to FIG. 5. Therefore, separate figures are not provided for these servers. Regardless, however, persons having ordinary skill in the art will recognize the various different architectures that could be used for the construction of the servers.

Various software and/or firmware has been described herein. It is to be understood that this software and/or firmware can be stored on any computer-readable medium for use by or in connection with any computer-related system or method. In the context of this document, a computer-readable medium denotes an electronic, magnetic, optical, or other physical device or means that can contain or store a computer program for use by or in connection with a computer-related system or method. These programs can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device.

The computer-readable medium can be, for example but not limited to, an electronic, magnetic, optical, electromagnetic, infrared, or semiconductor system, apparatus, device, or propagation medium. More specific examples (a non-exhaustive list) of the computer-readable medium include an electrical connection having one or more wires, a portable computer diskette, a random access memory (RAM), a read-only memory (ROM), an erasable programmable read-only memory (EPROM, EEPROM, or Flash memory), an optical fiber, and a portable compact disc read-only memory (CDROM). Note that the computer-readable medium can even be paper or another suitable medium upon which a program is printed, as the program can be electronically captured, via for instance optical scanning of the paper or other medium, then compiled, interpreted or otherwise processed in a suitable manner if necessary, and then stored in a computer memory.

Example systems having been described above, operation of the systems will now be discussed. In the discussions that follow, flow diagrams are provided. It is to be understood that any process steps or blocks in these flow diagrams represent modules, segments, or portions of code that include one or more executable instructions for implementing specific logical functions or steps in the process. It will be appreciated that, although particular example process steps are described, alternative implementations are feasible. Moreover, steps may be executed out of order from that shown or discussed, including substantially concurrently or in reverse order, depending on the functionality involved.

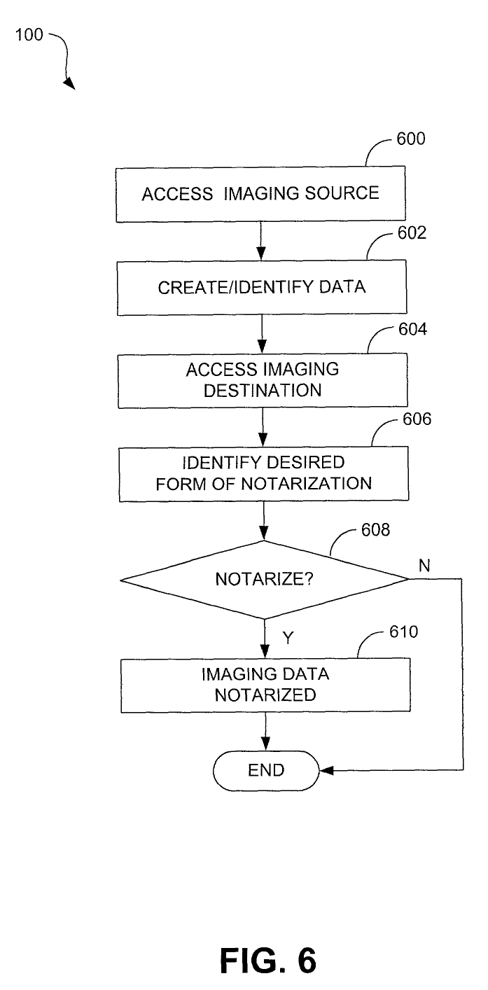

FIG. 6 provides an overview of the manner in which the inventive system is used to facilitate notarization. As shown in this figure, the system 100 is identified as a generic system for providing the notarization services. It is to be understood, however, that the system that is used can comprise any one of the systems described above, combinations thereof, or another system that incorporates one or more components of the systems described above.

As indicated in block 600, an imaging source 102 is first accessed by the user. By way of example, this source can comprise a network-based (e.g., web-based) service. Alternatively, the imaging source can comprise a local application that the user executes on his or her computing device. Regardless, once the imaging source is accessed, the user creates or identifies imaging data that is to be notarized, as indicated in block 602. By way example, data can be created/identified with a suitable user application, such as a word processing application. Where the data are created by the user, the user may further select the arrangement (i.e., composition) of the data. Notably, the data may include text as well as one or more graphics.

At this point, an imaging destination 104 can be accessed, as indicated in block 604, so that the imaging data can be notarized in some manner. By way of example, the imaging destination 104 comprises a network-based (e.g., web-based) notarization service that comprises a web site. Once the imaging destination 104 is accessed, the user can identify the form of notarization that is desired, as indicated in block 606. Where only one form of notarization is offered by the imaging destination 104, this identification can merely comprise identifying the form of notarization that is offered. It can then be determined whether the created/identified imaging data are to be notarized, as indicated in decision element 608. If not, flow for the session is terminated. If notarization is desired, however, the user initiates the notarization process and the imaging data are notarized, as indicated in block 610.

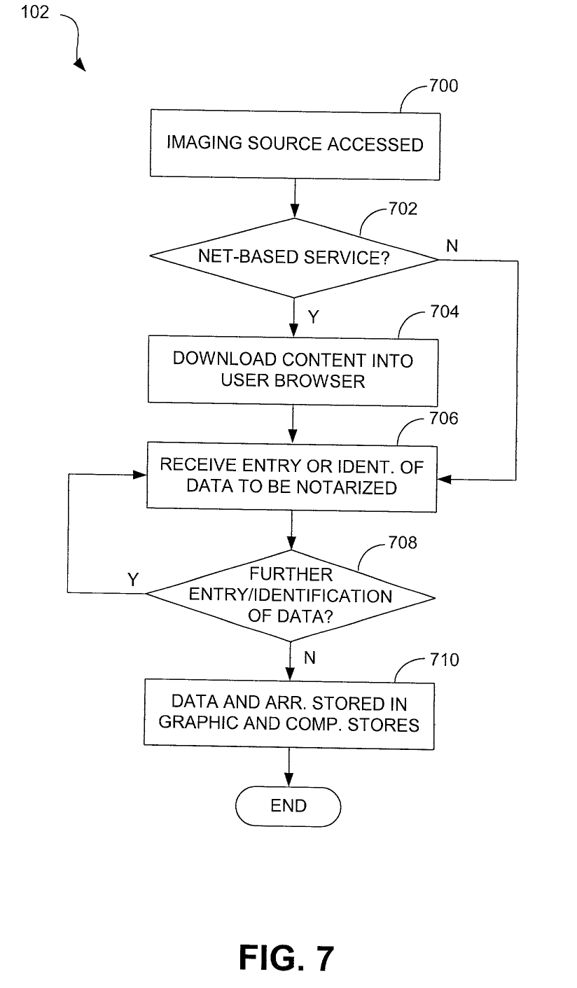

Referring now to FIG. 7, an example of use of an imaging source 102 in creating and/or identifying data to be notarized is provided. As noted above, the imaging source 102 can have various different arrangements. For instance, the imaging source 102 can simply comprise a local application (e.g., word processing application) that executes on the client device 302. In another example, the imaging source 102 can comprise a network-based (e.g., web-based) service with which data can be created, identified, and/or arranged by the user. Where the imaging source 102 comprises a network-based service, the user may access the source with a browser 304. In such a scenario, the service typically comprises a web site that is accessed via the Internet (public or private).

Irrespective of its configuration, the imaging source 102 is first accessed by the user, as indicated in block 700. The operation from this point forward may, however, depend upon whether the imaging source 102 is a local application or a network-based service. Referring to block 702, if the imaging source 102 is not a network-based service, flow continues down to block 706 described below. If, on the other hand, the imaging source 102 is a network-based service, flow continues to block 704 at which the imaging source 102 downloads content 306 into the user browser. As noted above, this content 306 normally includes various text and/or graphics that are displayed to the user to facilitate interfacing between the user and the service. As described above with reference to FIG. 3, this content 306 can, optionally, include generic access instructions 308 that call on methods of an imaging extension 310 of the browser 304 to perform various web imaging operations.

After the imaging source 102 has been accessed, the source can receive entry or identification of data (i.e., graphics), as indicated in block 706. For example, the imaging source 102 can receive data manually entered by the user via the user interface devices 504 of the client device 302. Alternatively, the user can identify the location of data (e.g., a formerly created document) that resides in memory 502 of the client device 302 or in a network-accessible location remote from the device memory. Once the data have been received and/or identified, it can be determined whether further data are to be entered and/or identified, as indicated in decision element 708. If further data are to be entered and/or identified, flow returns to 706 at which these data are received. If no further data are to be entered and/or identified, however, flow continues on to block 710 at which the received data, as well as the arrangement (i.e., composition) of the data, are stored within the personal imaging repository 320. More specifically, the data can be stored within the graphic store 336 and the arrangement of the data can be stored within the composition store 346. Again, the graphic store 336 and the composition store 346 can comprise the same store in which case the data and arrangement (i.e., imaging data) are stored in the same location. It is noted that the imaging source 102 typically is unaware that it is preparing imaging information for the purpose of notarization (as was indicated in FIG. 7). Therefore, imaging data prepared by the source 102 could be used for purposes other than notarization.

Where the imaging source 102 is a network-based service, storage of the imaging data can be facilitated through use of the imaging extension 310 stored in the user browser 304 and/or an imaging extension 412 stored on web server 408. In the former case, the content 306 downloaded to the browser 304 makes a call (e.g., API call) to the imaging extension 310 to, in turn, cause a call to be made to the user profile store 324 that contains the user profile 326. Through this call, the default graphic store 336 can be accessed and various graphics can be stored therein.

In the example system 400 of FIG. 4, storage of the imaging data is accomplished through use of the imaging extension 412. In particular, when the imaging source 102 was first accessed, the user's browser 304 can have been redirected by the content 306 downloaded into the browser to an authentication service and the user provided with an opportunity to complete an authentication procedure that identifies both the user's identity and the location of the user's personal imaging repository 320. Once the authentication procedure has been successfully completed, the browser 304 is again redirected and the user information, or at minimum the location of the user profile 326, is supplied to the notarization service. With this information, the service can then access the user's personal imaging repository 320 by making a call to the imaging extension 412 to command the imaging extension to make a call to the user profile store 324 of the personal imaging repository 320. It is noted that, although use of an imaging extension is specifically identified, persons having ordinary skill in the art will appreciate that, alternatively, the service can directly call the user profile store 324. In such a case, the service can, for instance, use a collection of stubs that are configured to call various elements of the personal imaging repository 320.

It is to be noted that the graphic store 336 and/or composition store 346 can, in some arrangements, form part of or be supported by the imaging source 102. Accordingly, where the imaging source 102 comprises a local application, the stores 336, 346 may be located within memory 502 of the client device 302. Where the imaging source 102 comprises a network-based service, the stores 336, 346 may be located on one or more servers that are accessible over the network 204.

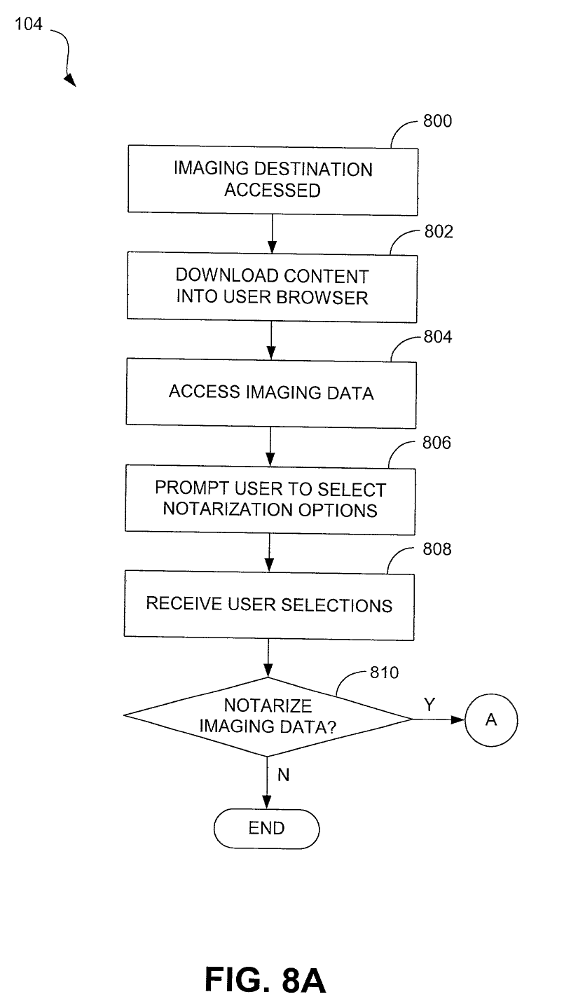

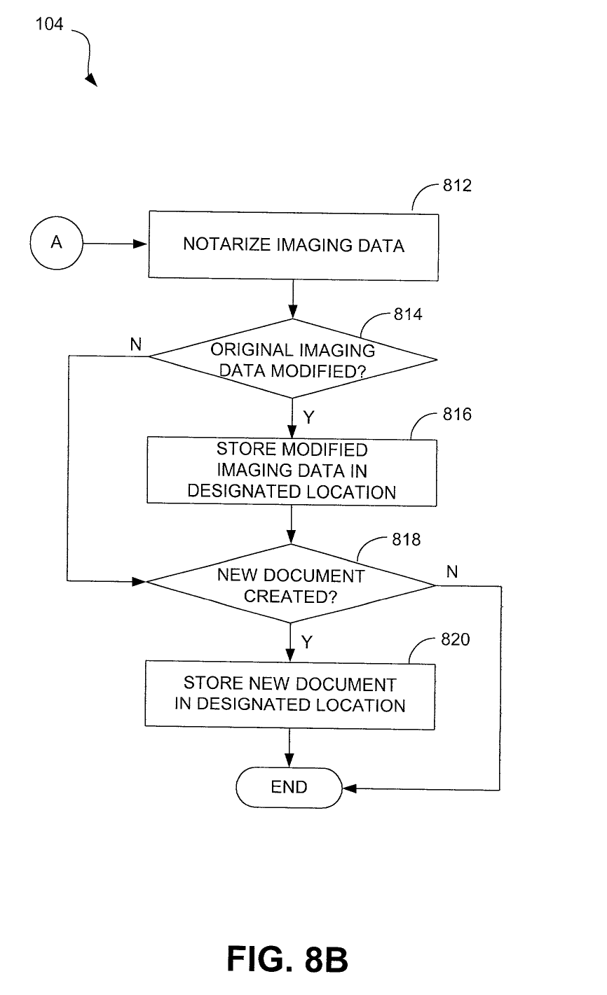

FIGS. 8A and 8B provide an example of operation of an imaging destination 104 in providing notarization services to a user. Beginning with block 800 of FIG. 8A, the imaging destination 104 is first accessed. Typically, this access is achieved by browsing to the imaging destination 104 over a network. By way of example, the imaging destination 104 comprises a notarization service that includes a web site that is accessed via the Internet. The notarization service can, for instance, comprise an officially-sanctioned notarization authority that is certified to provide official public notarization services. In some arrangements, secure communication technologies (e.g., public or private key cryptography) is used to maintain the integrity of the system and the reliability of the notarization obtained. For instance, a two-way validation scheme can be used in which the service provides a digital signature/certificate to the user to confirm the identity of the service and the user also provides a digital signature/certificate to confirm his or her identity to the service, such as may be the case in Secure Socket Layer (SSL) facilitated communication. Alternatively, other security measures could be used. For instance, the user can participate in a log in procedure in which the user provides the notarization service with a user name and password, both of which the user previously provided to the service.

In any case, once the imaging destination 104 (i.e., notarization service) is accessed, it downloads content 306 into the user's browser 304, as indicated in block 802. This content 306 normally includes various text and/or graphics that are displayed to the user to facilitate interfacing between the user and the service. Where the system is arranged as shown in FIG. 3, the content 306 can also include generic access instructions 308 that call on methods of the imaging extension 310 of the browser 304 so that the user's personal imaging repository 320 can be accessed. Where the system is arranged as shown in FIG. 4, the imaging extension 418 of the imaging destination 104 can be used to access the personal imaging repository 320. In this latter case, the imaging extension 418 knows the location of the personal imaging repository 320 from information provided to the imaging destination with, for example, a redirection address (e.g., URL).

Next, the notarization service accesses the imaging data (e.g., document) that are to be printed, as indicated in block 804. Where the imaging source 102 comprises a local application that executes on the client device 302, this access can be facilitated by uploading the imaging data to the service or by entering the location (i.e., address) of the imaging data so that it can be retrieved. Alternatively, where the imaging source 102 comprises a network-based service, the notarization service can gain access by automatic reference to the user's personal imaging repository 320 using an imaging extension 310 or 418. Assuming the user had just created and/or identified the document(s) using a network-based service, the imaging data comprises the default graphics and default composition that were stored by the network-based service.

The notarization service can also prompt the user to select the notarization options, as indicated in block 806. Several different notarization methods can be used. For example, the notarization can comprise a traditional form of notarization in which the original imaging data (e.g., a document) is “stamped” and “signed.” In terms of stamping, the original document can be provided with a watermark seal, a barcode that comprises information about the notarization service that notarized the imaging data and when the data were notarized, etc. Any of these pieces of information could be provided on one, several, or all of the pages of imaging data, as desired. As for the signature, a digital signature can be associated with the imaging data that identifies the notarization service as well as the date the notarization occurred. Alternatively, a notarization certificate can be generated that contains the various information concerning the notarization (e.g., identification of the notarization service, the authorization of the service, a notarization serial number, the date the imaging data were notarized, etc.). The certificate can, optionally, include thumbnail views of the original imaging data for added authenticity. In another alternative, the notarization can be recorded internally by the notarization service such that the user (i.e., author) could forward any inquiries regarding the imaging data to the notarization service.

Once the user's selections have been entered, they are received by the notarization service, as indicated in block 808, and it can be determined whether imaging data is to be notarized, as indicated in decision element 810. If not, flow is terminated. If the user does wish to have the imaging data notarized, however, flow continues to block 812 of FIG. 8B at which the notarization is performed by the service.

Where the original imaging data are modified in some way because of the notarization or where a notarization certificate has been created, a copy typically is provided for the user's records. Accordingly, with reference to decision element 814, if the original imaging data was modified, flow continues to block 816, at which the modified imaging data (e.g., a stamped and signed version of an original document) is stored in a designated location. By way of example, the location can comprise the user personal imaging repository 320. If the original imaging data have not been modified, flow continues to decision element 818 at which it is determined whether a separate document (e.g., notarization certificate) has been created. If not, flow for the session is terminated. If so, however, flow continues to block 820 at which the document is stored in a designated location (e.g., personal imaging repository 320).

While particular embodiments of the invention have been disclosed in detail in the foregoing description and drawings for purposes of example, it will be understood by those skilled in the art that variations and modifications thereof can be made without departing from the scope of the invention as set forth in the following claims.

What is claimed is:

1. A method for notarizing imaging data, comprising the steps of:
accessing imaging data via a network; and
electronically notarizing the imaging data.

2. The method of claim 1, wherein the step of accessing imaging data comprises receiving a document with a network-based notarization service.

3. The method of claim 1, wherein the step of accessing imaging data comprises accessing a document in a user personal imaging repository with a network-based notarization service.

4. The method of claim 3, wherein the step of accessing imaging data comprises accessing imaging data through use of an imaging extension.

5. The method of claim 4, wherein the imaging extension comprises part of a user browser.

6. The method of claim 4, wherein the imaging extension comprises part of the network-based notarization service.

7. The method of claim 1, wherein the step of electronically notarizing imaging data comprises modifying the imaging data by adding at least one of a stamp and a digital signature to the imaging data.

8. The method of claim 7, further comprising storing the modified imaging data.

9. The method of claim 8, wherein the modified imaging data are stored in a user personal imaging repository.

10. The method of claim 1, wherein the step of electronically notarizing imaging data comprises generating a notarization certificate.

11. The method of claim 10, further comprising storing the notarization certificate.

12. The method of claim 11, wherein the notarization certificate is stored in a user personal imaging repository.

13. A system for notarizing imaging data, comprising:
means for accessing imaging data via a network; and
means for electronically notarizing the imaging data.

14. The system of claim 13, wherein the means for accessing imaging data comprises means for receiving imaging data with a network-based notarization service.

15. The system of claim 13, wherein the means for accessing imaging data comprises means for accessing a document in a user personal imaging repository with a network-based notarization service.

16. The system of claim 15, wherein the means for accessing a document in a user personal imaging repository comprises an imaging extension.

17. The system of claim 16, wherein the imaging extension comprises part of a user browser.

18. The system of claim 16, wherein the imaging extension comprises part of the network-based notarization service.

19. The system of claim 13, wherein the means for electronically notarizing imaging data comprise means for modifying the imaging data by adding at least one of a stamp and a digital signature to the imaging data.

20. The system of claim 13, wherein the means for electronically notarizing imaging data comprise means for generating a notarization certificate.

21. A network-based notarization service stored on computer-readable media, comprising:
logic configured to access a document stored in a personal imaging repository; and
logic configured to electronically notarize the document.

22. The service of claim 21, wherein the logic configured to electronically notarize the document comprises logic configured to modify the document by adding at least one of a stamp and a digital signature to the document.

23. The service of claim 21, wherein the logic configured to electronically notarize the document comprises logic configured to generate a notarization certificate.
